(19) United States
(12) Patent Application Publication
(10) Pub. No.: US 2019/0061136 A1
(43) Pub. Date: Feb. 28, 2019

(54) Telescopic Ratchet Wrench Assembly

(71) Applicant: Wen-Kun Huang, Tainan City (TW)

(72) Inventor: Wen-Kun Huang, Tainan City (TW)

(21) Appl. No.: 15/691,803

(22) Filed: Aug. 31, 2017

(51) Int. Cl. B25G 1/04; B25B 13/46; B25B 23/00

(52) U.S. Cl. CPC B25G 1/043; B25B 23/0028; B25B 13/461

(57) ABSTRACT

A telescopic ratchet wrench assembly includes a first rod and a second rod. The first rod includes a first end having a first ratchet head. The first rod includes an insertion hole with an opening in a second end of the first rod. A positioning device is mounted in the insertion hole adjacent to the opening. The second rod includes an insertion section insertable into the insertion hole. A coupling section is pivotably connected to an end of the insertion section about a pivotal axis. The first rod and the second rod are coupled with each other to form a telescopic rod positionable by the positioning device. The second rod is movable to a pivotal position in which the pivotal axis is located outside of the first rod. The insertion section of the second rod in the pivotal position is pivotable relative to the coupling section about the pivotal axis.

### BACKGROUND OF THE INVENTION

The present invention relates to a telescopic ratchet wrench assembly and, more particularly, to a telescopic ratchet wrench assembly providing increased use convenience.

A conventional ratchet wrench generally includes a first end having a ratchet head and a second end with a handle portion. The ratchet head can be coupled with a socket or a tool to be rotated. However, the conventional ratchet wrench has a fixed length and, thus, cannot be used in a long-distance operation. Thus, the conventional ratchet wrench must be connected to an extension rod in the long-distance operation, which is inconvenient in use and which reduces the torque.

Telescopic ratchet wrenches have been provided to avoid the above disadvantages and can telescope to reduce the overall length for storage when not in use or to increase the overall length (an extended state) for a long-distance operation. However, the telescopic ratchet wrenches in the extended state have a large radius of rotation and, thus, occupy a considerable space, such that a hand of the user must move through a large range, leading to inconvenient use.

### BRIEF SUMMARY OF THE INVENTION

An objective of the present invention is to provide a telescopic ratchet wrench assembly providing an adjustable overall length and increased operational convenience.

A telescopic ratchet wrench assembly according to the present invention includes a first rod and a second rod. The first rod includes a first end and a second end spaced from the first end along a first longitudinal axis. The first end of the first rod includes a first ratchet head having a first engaging end extending perpendicularly to the first longitudinal axis of the first rod. The first rod includes a central portion having an insertion hole with an opening in the second end of the first rod. A positioning device is mounted in the insertion hole adjacent to the opening. The second rod includes an insertion section insertable into the insertion hole of the first rod. The insertion section includes an end facing the first rod. A coupling section is pivotably connected to the end of the insertion section about a pivotal axis. The first rod and the second rod are coupled with each other to form a telescopic rod positionable by the positioning device. The second rod is movable along the first longitudinal axis to a pivotal position in which the pivotal axis is located outside of the opening of the insertion hole of the first rod. The insertion section of the second rod in the pivotal position is pivotable relative to the coupling section about the pivotal axis.

In an example, the second rod extends along a second longitudinal axis. The second rod includes an end having a second ratchet head connected to the insertion section. The second ratchet head includes a second engaging end extending perpendicularly to the second longitudinal axis of the second rod.

In an example, the insertion section is pivotable clockwise or counterclockwise relative to the coupling section through an angle of about 90°.

In an example, the coupling section includes two lugs spaced from each other. Each of the two lugs includes a pivotal hole. The insertion section includes a pivotal portion received between the two lugs and having a pivotal hole. The insertion section and the coupling section are pivotably connected by a pin extending through the pivotal holes of the two lugs and the pivotal hole of the pivotal portion.

In an example, the positioning device includes a control sleeve and a positioning ball. The positioning ball is controllable by the control sleeve to move in a direction toward the insertion hole to a positioning position or in another direction away from the insertion hole to a disengagement position.

In an example, the coupling section includes a positioning portion. The positioning ball engages with the positioning portion of the coupling section when the second rod is in the pivotal position. The insertion section includes a plurality of positioning portions spaced from each other along the second longitudinal axis. The positioning ball is selectively engaged with one of the plurality of positioning portions of the insertion section when the insertion section of the second rod is received in the insertion hole of the first rod.

In an example, the pivotal portion of the insertion section includes a plurality of positioning teeth spaced from each other in an angular direction about the pivotal axis. The plurality of positioning teeth defines a plurality of positioning grooves. The coupling section includes a positioning member mounted between the two lugs. The positioning member is biased to engage with one of the plurality of positioning grooves defined by the plurality of positioning teeth.

The present invention will become clearer in light of the following detailed description of illustrative embodiments of this invention described in connection with the drawings.

### DESCRIPTION OF THE DRAWINGS

FIG. 1 is an exploded, perspective view of a telescopic ratchet wrench assembly according to the present invention.

FIG. 2 is a perspective view of the telescopic ratchet wrench assembly of FIG. 1, with the telescopic ratchet wrench assembly in a fully folded state.

FIG. 3 is a perspective view of the telescopic ratchet wrench assembly of FIG. 1, with the telescopic ratchet wrench assembly in an extended state, and with a coupling portion received in a first rod.

FIG. 4 is a diagrammatic cross sectional view illustrating use of the telescopic ratchet wrench assembly coupled with a socket for driving a fastener.

FIG. 4A is an enlarged view of a circled portion of FIG. 4.

FIG. 5 is perspective view of the telescopic ratchet wrench assembly of FIG. 1, with the telescopic ratchet wrench assembly in a fully extended state, and with the coupling portion located outside of the first rod.

FIG. 6 is a diagrammatic cross sectional view illustrating use of the telescopic ratchet wrench assembly of FIG. 5, with a second rod pivoted through an angle relative to the first rod, and with a first ratchet head of the first rod coupled with the socket for driving the fastener.

FIG. 7 is a top view of the telescopic ratchet wrench assembly of FIG. 6, illustrating operation of the telescopic ratchet wrench assembly for loosening the fastener.

FIG. 8 is a diagrammatic cross sectional view illustrating use of the telescopic ratchet wrench assembly of FIG. 5, with the first rod pivoted through an angle relative to the second rod, and with a second ratchet head of the second rod coupled with the socket for driving the fastener.

### DETAILED DESCRIPTION OF THE INVENTION

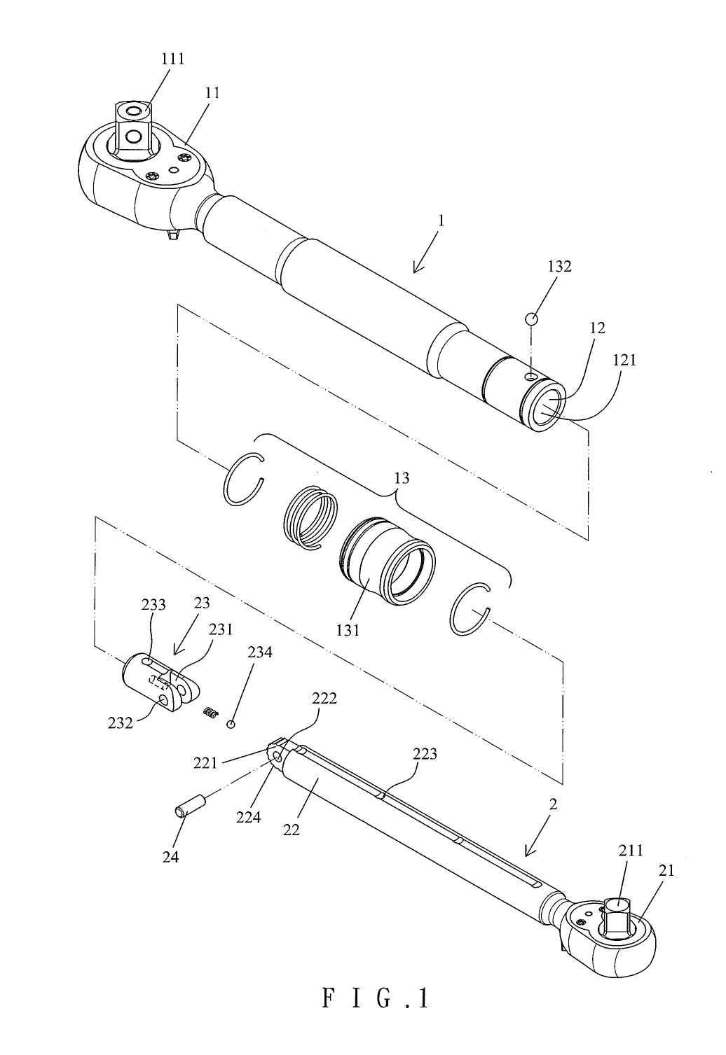

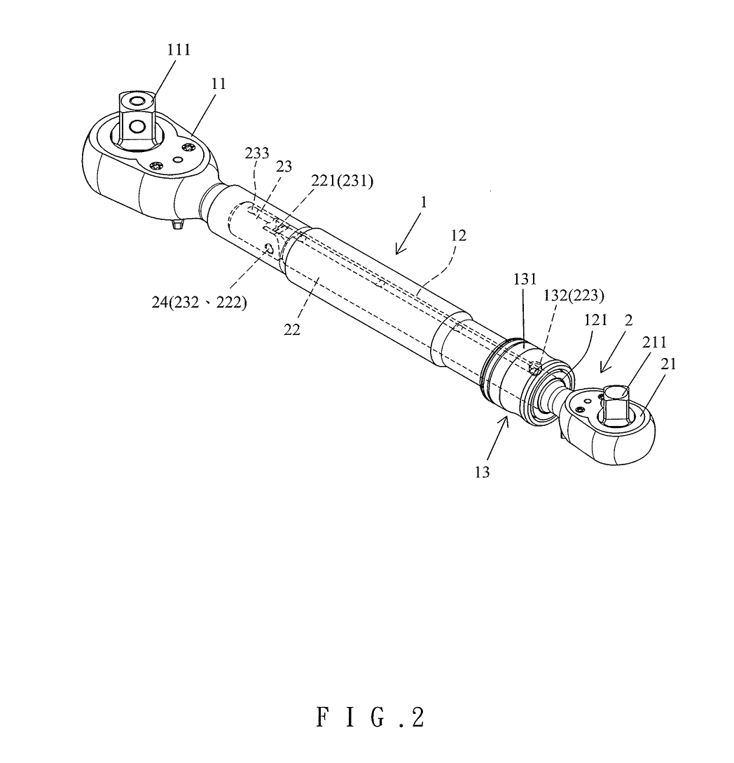

With reference to FIGS. 1-4, a telescopic ratchet wrench assembly according to the present invention includes a first rod 1 and a second rod 2. The first rod 1 includes a first end and a second end spaced from the first end along a first longitudinal axis. The first end of the first rod 1 includes a first ratchet head 11 having a first engaging end 111 extending perpendicularly to the first longitudinal axis of the first rod 1. The first rod 1 further includes a central portion having an insertion hole 12 with an opening 121 in the second end of the first rod 1. A positioning device 13 is mounted in the insertion hole 12 adjacent to the opening 121. The positioning device 13 includes a control sleeve 131 and a positioning ball 132. The positioning ball 132 is controllable by the control sleeve 131 to move in a direction toward the insertion hole 12 to a positioning position or in another direction away from the insertion hole 12 to a disengagement position.

The second rod 2 extends along a second longitudinal axis and includes an end having a second ratchet wrench 21. The second ratchet head 21 includes a second engaging end 211 extending perpendicularly to the second longitudinal axis of the second rod 2. The second rod 2 further includes an insertion section 22 insertable into the insertion hole 12 of the first rod 1. The insertion section 22 includes an end facing the first rod 1. A coupling section 23 is pivotably connected to the end of the insertion section 22 about a pivotal axis. The coupling section 23 includes two lugs 231 spaced from each other. Each of the two lugs 231 includes a pivotal hole 232 defining a pivotal axis. The coupling section 23 includes a positioning portion 233. The positioning ball 132 engages with the positioning portion 233 of the coupling section 23 when the second rod 2 is in a pivotal position. A spring-biased positioning member 234 is mounted in the coupling portion 23 and is mounted between the two lugs 231.

The insertion section 22 includes a pivotal portion 221 received between the two lugs 231 and having a pivotal hole 222. The pivotal portion 221 of the insertion section 22 includes a plurality of positioning teeth 224 spaced from each other in an angular direction about the pivotal axis. The teeth 24 defines a plurality of positioning grooves. The positioning member 234 is biased to engage with one of the plurality of positioning grooves defined by the positioning teeth 224.

The insertion section 22 and the coupling section 23 are pivotably connected by a pin 24 extending through the pivotal holes 232 of the two lugs 231 and the pivotal hole 222 of the pivotal portion 221. The insertion section 22 is pivotable relative to the coupling section 23 through an angle about 90° in a clockwise or counterclockwise direction. The insertion section 22 further includes a plurality of positioning portions 223 spaced from each other along the second longitudinal axis. The positioning ball 132 is selectively engaged with one of the positioning portions 223 of the insertion section 22 when the insertion section 22 of the second rod 2 is received in the insertion hole 12 of the first rod 1.

The second rod 2 is movable along the first longitudinal axis of the first rod 1 to the pivotal position in which the pivotal axis is located outside of the opening 121 of the insertion hole 12 of the first rod 1. The insertion section 22 of the second rod 2 in the pivotal position is pivotable relative to the coupling section 23 about the pivotal axis.

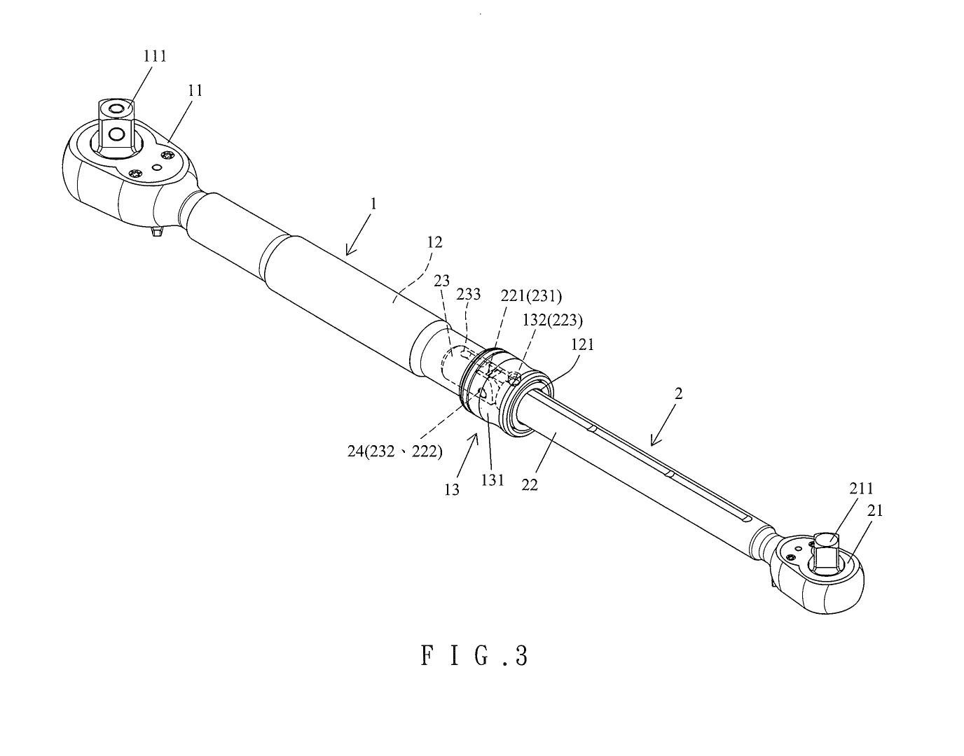

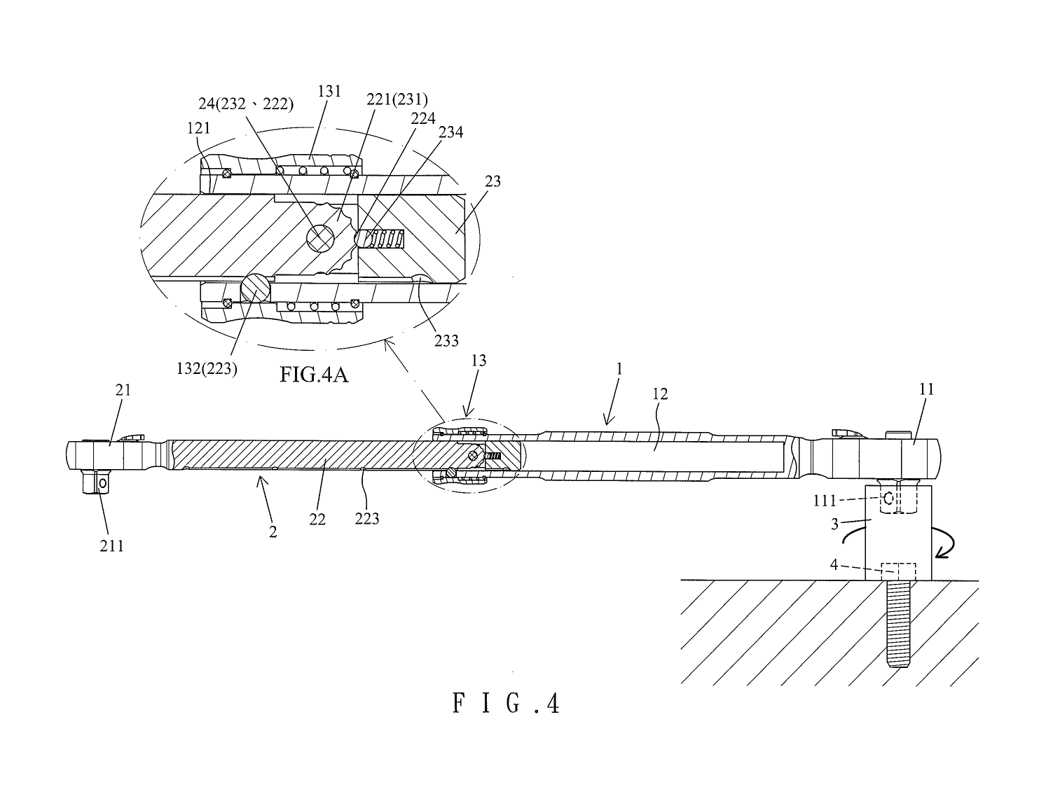

The first rod 1 and the second rod 2 are coupled with each other to form a telescopic rod positionable by the positioning device 13. In this embodiment, the insertion section 22 and the coupling section 23 of the second rod 2 are inserted into the insertion hole 12 of the first rod 1, forming a telescopic rod allowing adjustment of the overall length of the telescopic ratchet wrench assembly. With reference to FIGS. 3 and 4, the coupling portion 23 is received in the insertion hole 12 of the first rod 1. The positioning ball 132 engages with one of the positioning portions 223 of the insertion section 22. The first engaging end 111 the first ratchet head 11 engages with a socket 3. Since the coupling section 23 is received in the insertion hole 12 and is covered by the peripheral wall of the insertion hole 12, a proper torque can be imparted to a fastener 4, such as a bolt, coupled with the socket 3 to avoid the two lugs 231 from breaking during tightening or loosening operation of the fastener 4.

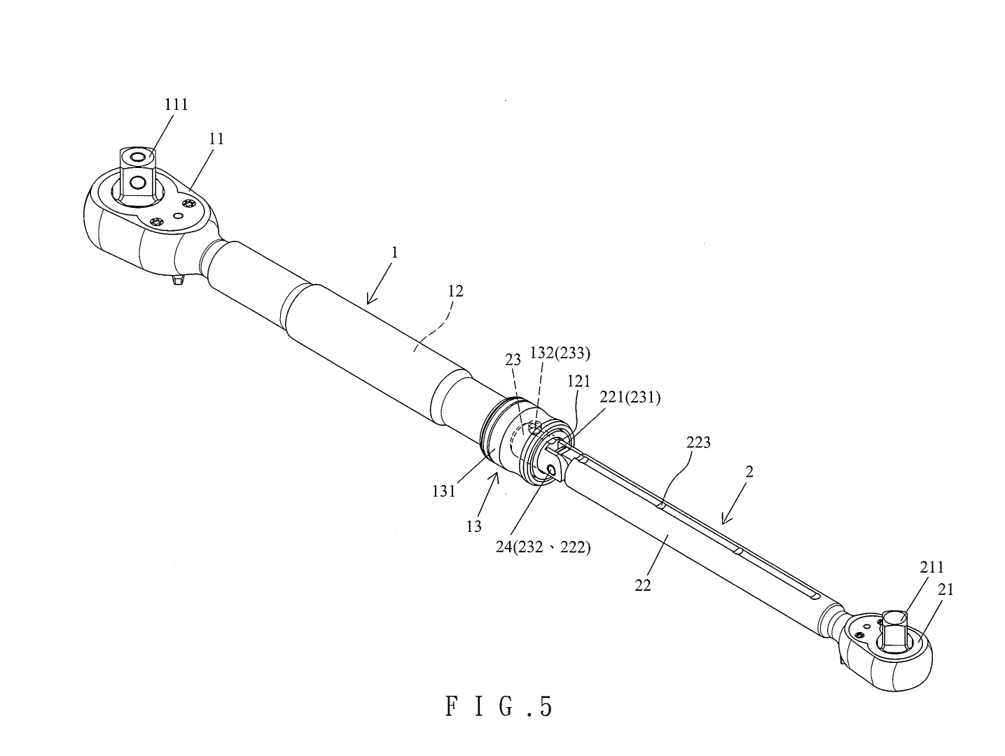

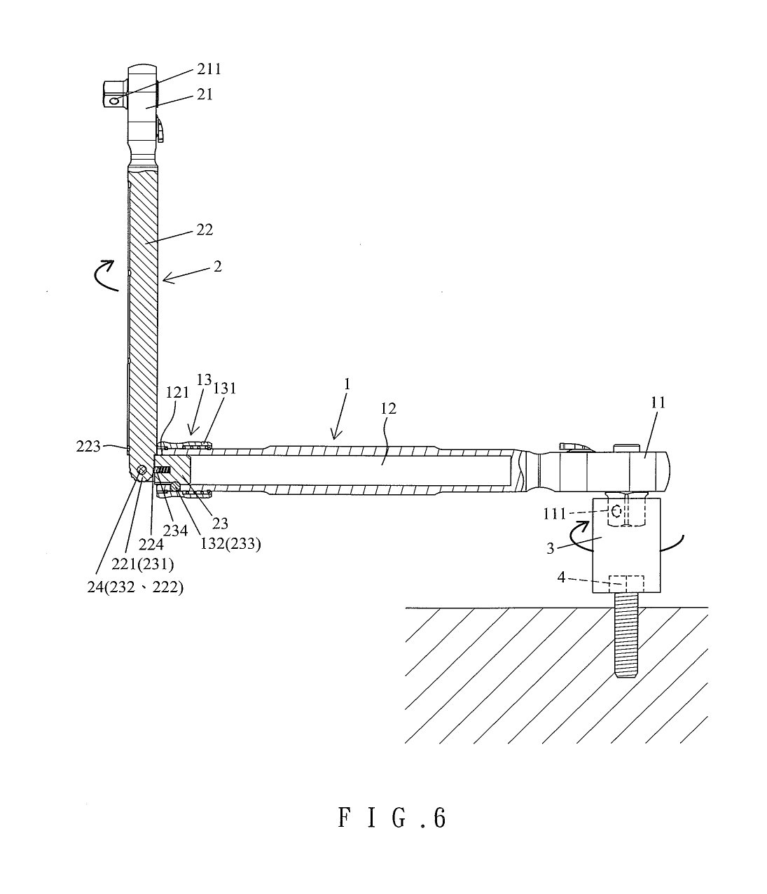

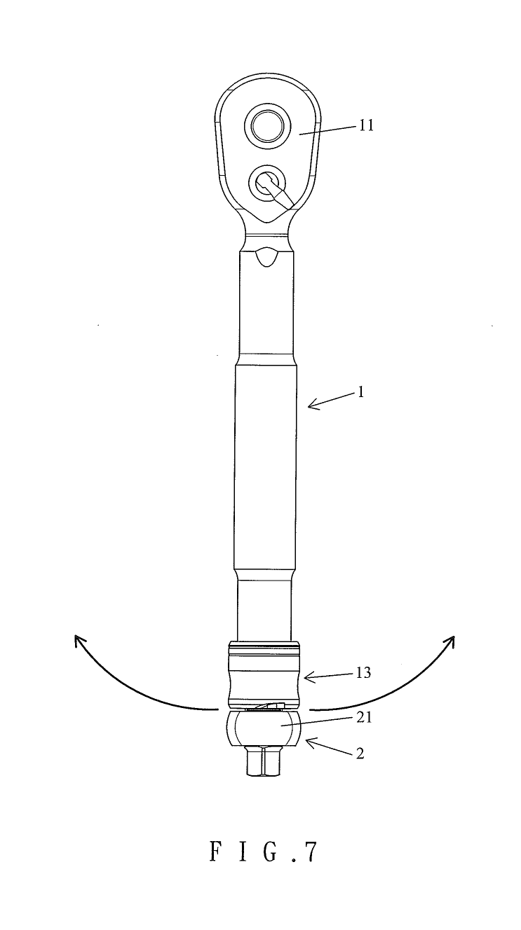

With reference to FIG. 5, after the fastener 4 has been loosened to an extent, the second rod 2 is moved relative to the first rod 1 along the first longitudinal axis until the pivotal hole 232 of the coupling section 23 is located outside of the opening 121 of the insertion hole 12, and the positioning portion 233 of the coupling section 23 engages with the positioning ball 132 of the positioning device 13. As shown in FIGS. 6 and 7, the insertion section 22 is pivoted 90° relative to the coupling section 23, and the positioning member 234 are engaged with the positioning teeth 224 to provide a positioning effect. The user can hold and rotate the second rod 2 with a smaller rotation of radius for completely loosening and removing the fastener 4, providing increased operational convenience. Since the fastener 4 has been partially loosened beforehand, the user can loosen the fastener 4 with a smaller torque in the subsequent operation, assuring the operational stability and prolonging the service life of the telescopic ratchet wrench assembly.

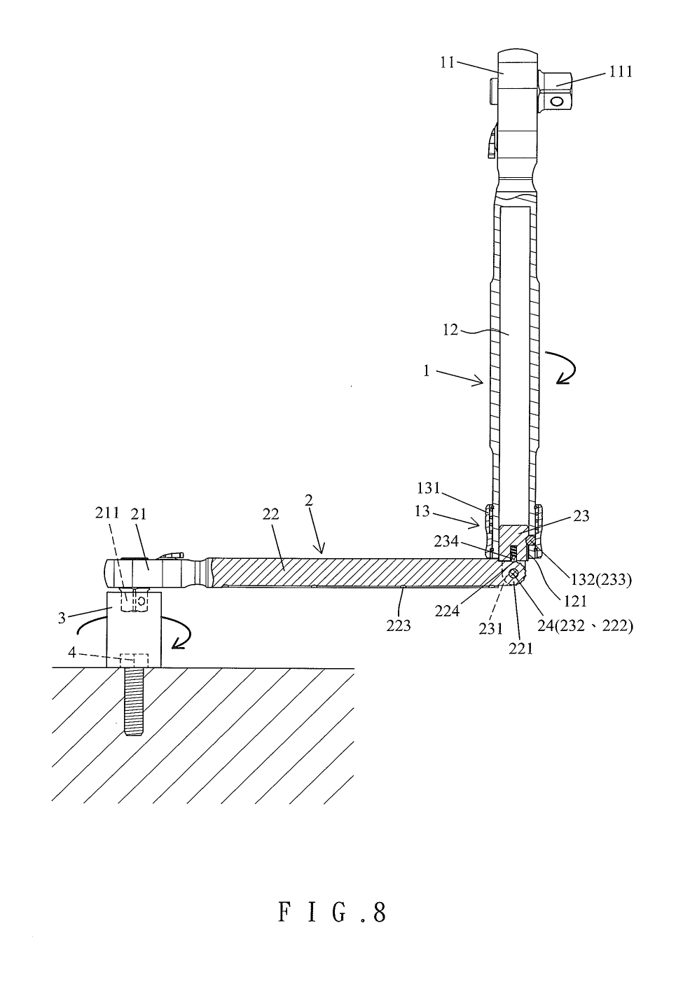

Alternatively, the second coupling end 211 of the second rod 2 can be used to couple with the socket 3 for coupling with the fastener 4. With reference to FIG. 8, after the fastener 4 has been loosened to an extent, the first rod 1 is moved relative to the second rod 2 until the pivotal hole 232 of the coupling section 23 is located outside of the opening 121 of the insertion hole 12, and the positioning portion 233 of the coupling section 23 engages with the positioning ball 132 of the positioning device 13. The first rod 1 is pivoted 90° relative to the second rod 2, and the positioning member 234 engages with the positioning teeth 224 to provide a positioning effect. The user can hold and rotate the first rod 1 with a smaller rotation of radius for completely loosening and removing the fastener 4, providing increased operational convenience.

In view of the foregoing, the telescopic ratchet wrench assembly provides an increased effect in use. It can be appreciated that the telescopic ratchet wrench assembly can use other positioning mechanisms other than the positioning device 3. Furthermore, the second rod 2 does not have to include the second ratchet head 21.

Although specific embodiments have been illustrated and described, numerous modifications and variations are still possible without departing from the scope of the invention. The scope of the invention is limited by the accompanying claims.

1. A telescopic ratchet wrench assembly comprising:
a first rod including a first end and a second end spaced from the first end along a first longitudinal axis, wherein the first end of the first rod includes a first ratchet head having a first engaging end extending perpendicularly to the first longitudinal axis of the first rod, wherein the first rod includes a central portion having an insertion hole with an opening in the second end of the first rod, wherein a positioning device is mounted in the insertion hole adjacent to the opening; and
a second rod including an insertion section insertable into the insertion hole of the first rod, wherein the insertion section includes an end facing the first rod, wherein a coupling section is pivotably connected to the end of the insertion section about a pivotal axis,
wherein the first rod and the second rod are coupled with each other to form a telescopic rod positionable by the positioning device,
wherein the second rod is movable along the first longitudinal axis to a pivotal position in which the pivotal axis is located outside of the opening of the insertion hole of the first rod, and wherein the insertion section of the second rod in the pivotal position is pivotable relative to the coupling section about the pivotal axis.

2. The ratchet wrench assembly as claimed in claim 1, wherein the second rod extends along a second longitudinal axis, wherein the second rod includes an end having a second ratchet head connected to the insertion section, wherein the second ratchet head includes a second engaging end extending perpendicularly to the second longitudinal axis of the second rod.

3. The ratchet wrench assembly as claimed in claim 2, wherein the insertion section is pivotable clockwise or counterclockwise relative to the coupling section through an angle of about 90°.

4. The ratchet wrench assembly as claimed in claim 2, wherein the coupling section includes two lugs spaced from each other, wherein each of the two lugs includes a pivotal hole, wherein the insertion section includes a pivotal portion received between the two lugs and having a pivotal hole, wherein the insertion section and the coupling section are pivotably connected by a pin extending through the pivotal holes of the two lugs and the pivotal hole of the pivotal portion.

5. The ratchet wrench assembly as claimed in claim 2, wherein the positioning device includes a control sleeve and a positioning ball, wherein the positioning ball is controllable by the control sleeve to move in a direction toward the insertion hole to a positioning position or in another direction away from the insertion hole to a disengagement position.

6. The ratchet wrench assembly as claimed in claim 5, wherein the coupling section includes a positioning portion, wherein the positioning ball engages with the positioning portion of the coupling section when the second rod is in the pivotal position, wherein the insertion section includes a plurality of positioning portions spaced from each other along the second longitudinal axis, and wherein the positioning ball is selectively engaged with one of the plurality of positioning portions of the insertion section when the insertion section of the second rod is received in the insertion hole of the first rod.

7. The ratchet wrench assembly as claimed in claim 4, wherein the pivotal portion of the insertion section includes a plurality of positioning teeth spaced from each other in an angular direction about the pivotal axis, wherein the plurality of positioning teeth defines a plurality of positioning grooves, wherein the coupling section includes a positioning member mounted between the two lugs, and wherein the positioning member is biased to engage with one of the plurality of positioning grooves defined by the plurality of positioning teeth.
